(19) United States
(12) Patent Application Publication
(10) Pub. No.: US 2025/0277441 A1
(43) Pub. Date: Sep. 4, 2025

(54) METHODS AND SYSTEMS FOR DETERMINING CONDUCTIVE HYDRAULIC FRACTURE CHARACTERISTICS VIA CROSS-WELL FIBER OPTIC MONITORING

(71) Applicant: ExxonMobil Technology and Engineering Company, Spring, TX (US)

(72) Inventors: Alexandros SOLOMOU, Spring, TX (US); Ripudaman MANCHANDA, Midland, TX (US); Dalton S. VICE, Houston, TX (US); James S. BROWN, Sugar Land, TX (US); Timothy G. BENISH, Spring, TX (US); Yueming LIANG, Sugar Land, TX (US); Holger A. MEIER, Montgomery, TX (US)

(21) Appl. No.: 19/051,420

(22) Filed: Feb. 12, 2025

Related U.S. Application Data
(60) Provisional application No. 63/559,315, filed on Feb. 29, 2024.

(51) Int. Cl. E21B 47/08; E21B 43/267; G01L 1/24; G01V 8/16

(52) U.S. Cl. CPC E21B 47/08; E21B 43/267; G01L 1/242; G01V 8/16

(57) ABSTRACT

A method includes identifying production wells that are likely to interact with a monitor well and hydraulically fracturing each production well while measuring treatment strain data via fiber optic cable(s) at the monitor well. The method includes performing production interference test(s) for each production well, while measuring production strain data via the fiber optic cable(s); determining measured depths of fracture-driven interactions and an interaction corridor; and determining active measured depths along the monitor well based on correlations between the temporal strain response and the timing of the production interference tests. The method includes associating active measured depths with production well(s) that exhibited a reaction during the production interference test; for each active measured depth, determining an originating stage of a corresponding hydraulic fracture based on the interaction corridors; and determining conductive fracture dimensions based on a production well survey and coordinates of the originating stage and the active measured depth.

### CROSS-REFERENCE TO RELATED APPLICATION

This application claims priority to and the benefit of U.S. Provisional Application No. 63/559,315, entitled “METHODS AND SYSTEMS FOR DETERMINING CONDUCTIVE HYDRAULIC FRACTURE CHARACTERISTICS VIA CROSS-WELL FIBER OPTIC MONITORING,” having a filing date of Feb. 29, 2024, the disclosure of which is incorporated herein by reference in its entirety.

### FIELD

This disclosure relates generally to the field of hydrocarbon well completions and hydraulic fracturing operations. More specifically, this disclosure relates to determining the characteristics of conductive hydraulic fractures corresponding to one or more production wells using one or more offset monitor wells equipped with fiber optic cables.

### BACKGROUND

This section is intended to introduce various aspects of the art, which may be associated with embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Subsurface formations corresponding to low-permeability, unconventional hydrocarbon reservoirs are often stimulated using hydraulic fracturing techniques. Hydraulic fracturing consists of injecting a volume of fracturing fluid through created perforations and into the surrounding formation at such high pressures and rates that the rock in proximity to the perforations cracks open, resulting in the creation of hydraulic fractures that propagate both horizontally and vertically within the formation and are often abstracted as ellipses with a length and a height.

Once the fracturing fluid has created the hydraulic fractures within the subsurface formation, proppant is typically pumped into the hydraulic fractures. The proppant travels with the pumped fracturing fluid and is governed by the physics of particle transport. When the pumps are turned off, the hydraulic fractures lose hydraulic pressure due to leak-off and then close. However, the regions of the hydraulic fractures that include proppant are held open mechanically by the presence of the proppant. In this regard, the term “wetted hydraulic fracture” (or “wetted fracture” or simply “wetted region”) refers to the entire hydraulic fracture that has been created within the subsurface formation, while the term “conductive hydraulic fracture” (or “conductive fracture” or simply “conductive region”) refers to the region of the hydraulic fracture that remains hydraulically conductive once the pumps are turned off and the hydraulic pressure is released.

The created hydraulic fractures serve to increase the fluid permeability within the formation, thus permitting hydrocarbon fluids from the reservoir to flow into the wellbore and then be produced at the surface. In operation, the success of the hydraulic fracturing operation has a direct impact on the production characteristics of the hydrocarbon well. In particular, the dimensions (e.g., the lengths and heights) of the hydraulic fractures directly impact the hydrocarbon production operation, with larger hydraulic fractures effectively increasing the amount of hydrocarbon fluids that may be recovered from the reservoir. To that end, techniques have been developed to indirectly estimate hydraulic fracture dimensions. However, such techniques generally do not differentiate between the entire wetted hydraulic fractures and the conductive hydraulic fractures. This is an issue since, in general, the productivity of the corresponding well is defined by the conductive regions of the hydraulic fractures, with the remainder of the wetted regions of such hydraulic fractures not contributing strongly to production. Therefore, knowledge of the wetted fracture dimensions is not sufficient to predict well performance.

This problem is further compounded within the context of unconventional developments, which often include hundreds or even thousands of hydrocarbon wells. Due to the complexity of such unconventional developments, it becomes even more crucial to determine the dimensions of the conductive hydraulic fractures as the field is being developed. Specifically, information regarding such conductive hydraulic fracture dimensions can be used to guide the well spacing, stacking, and/or stimulation strategies that are employed during the development of the field (e.g., before the majority of the wells within the field are drilled and completed). Moreover, while a few techniques have been developed to provide some information regarding conductive fracture dimensions, such techniques generally involve indirectly estimating the conductive fracture dimensions by interpreting production data collected over many months using history matching and/or simulation-based techniques, rather than directly measuring the conductive fracture dimensions. As a result, such techniques are limited in value due to their high costs, low accuracy levels, and associated constraints.

### SUMMARY

An aspect of this disclosure provides a method for determining conductive fracture dimensions for production wells within a field. The method can comprise one or more of the following steps: identifying production wells within a field that are likely to interact with a monitor well within the field; hydraulically fracturing multiple stages of each production well to create hydraulic fractures extending within a subsurface formation; and during the hydraulic fracturing of the stages of each production well, measuring treatment strain data via a fiber optic cable deployed at the monitor well. The method also comprises performing a production interference test for each production well; during the production interference test for each production well, measuring production strain data via the fiber optic cable deployed at the monitor well; and for each stage of each production well, determining measured depths of fracture-driven interactions at the monitor well and an interaction corridor for the stage based on the measured treatment strain data. The method further comprises determining active measured depths along the monitor well based on a correlation between a temporal strain response for each measured depth and a time at which the production interference test was performed for each production well; associating each active measured depth with one or more production wells based on which of the production wells reacted to the active measured depth during the corresponding production interference test; for each active measured depth, determining an originating stage of a corresponding hydraulic fracture based on the determined interaction corridors for the stages of the one or more production wells that are associated with the active measured depth; and determining conductive fracture dimensions for each hydraulic fracture based on a survey for the production well comprising the originating stage, coordinates of the determined originating stage of the hydraulic fracture, and coordinates of the corresponding active measured depth along the monitor well.

A second aspect of this disclosure provides another method for determining conductive fracture dimensions for production wells within a field. The method can comprise one or more of the following steps: identifying production wells within a field that are likely to interact with a monitor well within the field, wherein each production well comprises multiple stages with associated hydraulic fractures extending within a subsurface formation; performing a production interference test for each production well; and during the production interference test for each production well, measuring production strain data via a fiber optic cable deployed at the monitor well. The method also comprises determining active measured depths along the monitor well based on a correlation between a temporal strain response for each measured depth and a time at which the production interference test was performed for each production well; and associating each active measured depth with one or more production wells based on which of the production wells reacted to the active measured depth during the corresponding production interference test. The method further comprises, for each active measured depth that has been associated with only one of the production wells, determining an originating stage of a corresponding hydraulic fracture based on a survey for the production well and data corresponding to an expected regional fracture azimuth; and for each hydraulic fracture for which the originating stage has been determined, determining conductive fracture dimensions for the hydraulic fracture based on the survey for the production well, coordinates of the determined originating stage of the hydraulic fracture, and coordinates of the corresponding active measured depth along the monitor well.

A third aspect of this disclosure provides a hydrocarbon well system. The hydrocarbon well system can comprise one or more of the following: multiple production wells within a field, wherein each production well comprises: a wellhead; and a wellbore extending from the wellhead into a subsurface formation, wherein the wellbore comprises a plurality of stages. The hydrocarbon well system also comprises a monitor well within the field, wherein the monitor well is within a vicinity of the production wells, and wherein the monitor well comprises: a wellhead; and a wellbore extending from the wellhead into the subsurface formation, wherein the wellbore is equipped with a fiber optic cable; and a computing system that is communicably coupled to the monitor well. The computing system comprises: a processor; and a non-transitory, computer-readable storage medium. The non-transitory, computer-readable storage medium comprises program instructions that are executable by the processor to cause the processor to: (a) during hydraulic fracturing of each stage of each production well, measure treatment strain data via the fiber optic cable of the monitor well; (b) during production interference testing for each production well, measure production strain data via the fiber optic cable of the monitor well; (c) for each stage of each production well, determine measured depths of fracture-driven interactions at the monitor well and an interaction corridor for the stage based on the measured treatment strain data; (d) determine active measured depths along the monitor well based on a correlation between a temporal strain response for each measured depth and a time at which the production interference test was performed for each production well; (c) associate each active measured depth with one or more production wells based on which of the production wells reacted to the active measured depth during the corresponding production interference test; (f) for each active measured depth, determine an originating stage of a corresponding hydraulic fracture based on the determined interaction corridors for the stages of the one or more production wells that has been associated with the active measured depth; and (g) determine conductive fracture dimensions for each hydraulic fracture based on a survey for the production well comprising the originating stage, coordinates of the determined originating stage of the hydraulic fracture, and coordinates of the corresponding active measured depth along the monitor well.

A fourth aspect of this disclosure provides a non-transitory, computer-readable storage medium. The non-transitory, computer-readable storage medium can comprise one or more of the following: program instructions that are executable by a processor to cause the processor to: (a) measure, via a fiber optic cable deployed at a monitor well, treatment strain data and production strain data corresponding to multiple production wells that are likely to interact with the monitor well within a field; (b) for each stage of each production well, determine a measured depth of each fracture-driven interaction at the monitor well and an interaction corridor for the stage based on a waterfall plot of the measured treatment strain data; (c) determine active measured depths along the monitor well based on a correlation between a temporal strain response for each measured depth and a time at which the production interference test was performed for each production well; (d) associate each active measured depth with one or more production wells based on which of the production wells reacted to the active measured depth during the corresponding production interference test; (e) for each active measured depth, determine an originating stage of a corresponding hydraulic fracture based on the determined interaction corridors for the stages of the one or more production wells that has been associated with the active measured depth; and (f) determine conductive fracture dimensions for each hydraulic fracture based on a survey for the production well comprising the originating stage, coordinates of the determined originating stage of the hydraulic fracture, and coordinates of the corresponding active measured depth along the monitor well.

These and other features and attributes of the disclosed aspects and embodiments of the present disclosure and their advantageous applications and/or uses will be apparent from the detailed description that follows.

### BRIEF DESCRIPTION OF THE DRAWINGS

To assist those of ordinary skill in the relevant art in making and using the subject matter described herein, reference is made to the appended drawings, where:

FIG. 1A is a schematic illustration of a gun barrel view of an exemplary field for which the aspects and/or embodiments of the present disclosure may be employed;

FIG. 1B is schematic illustration of a plan view of the exemplary field of FIG. 1A;

FIG. 2A is a first waterfall plot corresponding to the treatment strain data for a first production well;

FIG. 2B is a second waterfall plot corresponding to the treatment strain data for a second production well;

FIG. 2C is a third waterfall plot corresponding to production strain data for both production wells, as well as a third production well;

FIG. 3 is a plot of the strain response as a function of time at the measured depths corresponding to each of the strain change peak locations, where the strain response is measured for the duration of a production interference test;

FIG. 4A is a first plot of horizontal distance between each stage of the treatment well and the interacting active measured depths on the monitor well;

FIG. 4B is a second plot of vertical distance between each stage of the treatment well and the interacting active measured depths on the monitor well;

FIG. 4C is a third plot of the calculated fracture azimuths for the stages of the treatment well;

FIG. 5 is a process flow diagram of an exemplary method for determining conductive fracture characteristics for one or more production wells using strain data measured via a fiber-equipped monitor well during treatment and production via the production well(s), in accordance with the present disclosure;

FIG. 6 is a process flow diagram of an exemplary method for determining conductive fracture characteristics for one or more production wells using strain data measured via a fiber-equipped monitor well during production via the production well(s), in accordance with the present disclosure;

FIG. 7 is a block diagram of an exemplary cluster computing system that may be utilized to implement at least a portion of the aspects and/or embodiments provided by the present disclosure; and

FIG. 8 is a block diagram of an exemplary non-transitory, computer-readable storage medium that may be used for the storage of data and modules of program instructions for implementing at least a portion of the aspects and/or embodiments provided by the present disclosure.

It should be noted that the figures are merely examples of the present disclosure and are not intended to impose limitations on the scope of the present disclosure. Further, the figures are generally not drawn to scale, but are drafted for purposes of convenience and clarity in illustrating various aspects and/or embodiments of the present disclosure.

### DETAILED DESCRIPTION

In the following detailed description section, the specific examples of the present disclosure are described in connection with preferred aspects and embodiments. However, to the extent that the following description is specific to one or more aspects or embodiments of the present disclosure, this is intended to be for exemplary purposes only and simply provides a description of such aspect(s) or embodiment(s). Accordingly, the present disclosure is not limited to the specific aspects and embodiments described below, but rather, includes all alternatives, modifications, and equivalents falling within the true spirit and scope of the appended claims.

At the outset, and for case of reference, certain terms used in this application and their meanings as used in this context are set forth. To the extent a term used herein is not defined below, it should be given the broadest definition those skilled in the art have given that term as reflected in at least one printed publication or issued patent. Further, the present disclosure is not limited by the usage of the terms shown below, as all equivalents, synonyms, new developments, and terms or techniques that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the terms “example,” exemplary,” and “embodiment,” when used with reference to one or more components, features, structures, or methods according to the present disclosure, are intended to convey that the described component, feature, structure, or method is an illustrative, non-exclusive example of components, features, structures, or methods according to the present disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present disclosure.

As used herein, a “fiber optic cable” refers to a cable assembly that is externally attached to or otherwise deployed within the wellbore casing and includes one or more optical fibers, a laser source that generates a light pulse from a modulated or unmodulated electrical signal, and a receiver that is configured to detect the characteristics of the light pulse after it travels through the optical fiber(s) and then backscatters toward the receiver. According to embodiments described herein, the changes in the light pulse can then be used to determine an amount of strain within the fiber optic cable (among other parameters) and, thus, the subsurface environment within which the fiber optic cable is deployed. For simplicity, the data collected via the fiber optic cable are referred to herein as “strain data.”

As used herein, the term “field” (sometimes referred to as an “oil and gas field” or a “hydrocarbon field”) refers to an area including one or more hydrocarbon wells for which hydrocarbon production operations are to be performed to provide for the extraction of hydrocarbon fluids from a corresponding subsurface formation.

As used herein, the term “hydraulic fracture” (or “fracture”) refers to a crack or surface of breakage induced by an applied pressure or stress within a subsurface formation. Moreover, the term “wetted hydraulic fracture” (or “wetted fracture” or simply “wetted region”) refers to an entire hydraulic fracture that has been created within a subsurface formation, while the term “conductive hydraulic fracture” (or “conductive fracture” or simply “conductive region”) refers to the region of the hydraulic fracture that remains hydraulically conductive once the pumps are turned off and the hydraulic pressure is released. Therefore, the conductive hydraulic fractures within the subsurface formation are the primary contributors to the production of hydrocarbon fluids from the corresponding hydrocarbon well. Each conductive hydraulic fracture generally includes primarily the region of the corresponding wetted hydraulic fracture that was successfully propped with proppant, although it may also include one or more other region(s) of the wetted hydraulic fracture that remain hydraulically conductive for other reasons.

The term “hydraulic fracturing” refers to a process for creating fractures (also referred to as “hydraulic fractures”) that extend from a wellbore into a reservoir, so as to stimulate the flow of hydrocarbon fluids from the reservoir into the wellbore. A fracturing fluid is generally injected into the reservoir with sufficient pressure to create and extend multiple fractures within the reservoir, and a proppant material is used to “prop” or hold open the fractures after the hydraulic pressure used to generate the fractures has been released. Moreover, the terms “treatment” and “stimulation” may also be used herein with reference to a hydraulic fracturing operation.

As used herein, the term “monitor well” refers to a hydrocarbon well that is equipped with one or more fiber optic cables and is configured to utilize such fiber optic cable(s) to measure strain data corresponding to one or more production wells according to embodiments described herein. For example, such monitor well may include a slant well that is configured to measure strain data corresponding to one or more production wells within the vicinity of the monitor well.

As used herein, the term “production well” refers to a hydrocarbon well that is monitored via one or more monitor wells according to embodiments described herein. In this regard, the term “production well” is intended to encompass, not only hydrocarbon wells from which hydrocarbon fluids are currently being produced, but also hydrocarbon wells that are being stimulated or treated for future hydrocarbon production purposes (which are sometimes referred to as “treatment wells”).

Moreover, it should be noted that the terms “monitor well” and “production well” generally refer to the status of a hydrocarbon well at a given point in time, not necessarily a perpetual state. For example, a hydrocarbon well may undergo a hydraulic fracturing operation and, thus, be qualified as a production well during that period of time. Afterwards, the same well may be used to measure strain data for one or more other nearby hydraulic fracturing operations and/or production operations and, therefore, may be qualified as a monitor well during that period of time. If the same well is later put on production, the well may then be qualified as a production well again.

The terms “production interference testing” and “production interference test” are used herein to refer to a process of alternating between putting a production well on production and then shutting-in such well, while simultaneously measuring corresponding subsurface data (i.e., according to the present disclosure, strain data) via one or more offset monitor wells.

As used herein, the term “real-time” generally refers to the time delay resulting from detecting and transmitting relevant data regarding a physical event from one point (e.g., the data detection/sensing location, which may be a receiver of a fiber optic cable according to embodiments described herein) to another (e.g., the data monitoring location, which may be one or more computing systems according to embodiments described herein), as well as the time delay that allows for timely utilization of the data to control, adjust, or otherwise impact subsequent actions taken in response to the physical event (where such actions may be taken, in part, using one or more computing systems according to embodiments described herein, along with any corresponding physical actions that are taken in the field).

The terms “substantial,” “substantially,” “approximate,” and “approximately,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

As used herein, the term “surface” refers to the uppermost land surface of a land well, or the mud line of an offshore well, while the term “subsurface” generally refers to a geologic strata occurring below the earth's surface. Moreover, as used herein, “surface” and “subsurface” are relative terms. The fact that a particular piece of equipment is described as being on the surface docs not necessarily mean it must be physically above the surface of the earth but, rather, describes only the relative placement of the surface and subsurface pieces of equipment. In that sense, the term “surface” may generally refer to any equipment that is located above the casing strings and other equipment that is located inside the wellbore. Moreover, according to embodiments described herein, the terms “downhole” and “subsurface” are sometimes used interchangeably, although the term “downhole” is generally used to refer specifically to the inside of the wellbore.

The term “wellbore” refers to a borehole drilled into a subsurface formation. The borehole may include vertical, deviated, highly deviated, and/or horizontal (or lateral) sections. The term “wellbore” also includes the downhole equipment associated with the borehole, such as the casing strings, production tubing, and other subsurface equipment. Relatedly, the term “hydrocarbon well” (or simply “well”) includes the wellbore in addition to the wellhead and other associated surface equipment. Moreover, the term “hydrocarbon well system” is used herein to refer to all the hydrocarbon wells and associated equipment within a particular field of interest. More specifically, according to embodiments described herein, a hydrocarbon well system includes at least one monitor well, at least one production well, and at least one computing system that enables the direction and execution of various hydrocarbon development tasks with respect to any of the wells within the field, including, for example, stimulation and production-related tasks.

Turning now to details of the present disclosure, during the development of a hydrocarbon field, the completion effectiveness of the resulting production wells can generally be determined based on the success of the hydraulic fracturing operation, which can be quantified based on the resulting hydraulic fracture characteristics. However, even when the completion design is held constant, the characteristics of the hydraulic fractures could vary widely within and among stages due, at least in part, to the geologic variations within the subsurface formation, the lack of injection uniformity within and among stages, and the negative effects of stress shadowing, for example. As a result, techniques have been developed to indirectly estimate wetted fracture dimensions. However, because conductive fracture dimensions are more relevant to future production potential than the overall wetted fracture dimensions, knowledge of the wetted fracture dimensions is not sufficient to predict well performance and/or to guide well spacing, stacking, and/or stimulation strategies during field development. Accordingly, the present disclosure alleviates this difficulty by providing for the direct determination of conductive hydraulic fracture characteristics via cross-well fiber optic monitoring. More specifically, the present disclosure provides for the utilization of one or more offset monitor wells equipped with fiber optic cables to directly determine the origination (i.e., originating well and stage) and dimensions (e.g., length, height, and/or azimuth) of conductive hydraulic fractures corresponding to one or more production wells within a field. This is accomplished by leveraging the offset monitor well(s) equipped with the fiber optic cable(s) to determine localized strain changes induced by intersecting hydraulic fractures that originate from nearby production well(s) within the field. Specifically, during the treatment of a production well, the intersection locations of the hydraulic fractures with a monitor well (which are commonly referred as “wetted fractures hits” or “fracture-driven interactions”) are identified using temporal, high-resolution distributed strain data that are measured via the fiber optic cable(s) at the monitor well, enabling the determination of the wetted fracture dimensions. Subsequently, during production interference tests with respect to the production well, additional temporal, high-resolution distributed strain data measured via the fiber optic cable(s) at the monitor well are utilized, in combination with the determined wetted fracture dimensions, to identify the subset of hydraulic fractures that remain active (where the term “active” in this context means that the hydraulic fracture has maintained enough hydraulic conductivity to elicit a response at the monitor well), as well as to associate each active hydraulic fracture with a particular stage of the production well. This information is then utilized to determine the conductive fracture dimensions for each active hydraulic fracture, as described further herein.

The aspects and embodiments provided by the present disclosure advantageously utilize, in part, strain data that are measured via the fiber optic cable(s) at the monitor well(s) during production interference tests corresponding to each production well. As an example, for each production well that undergoes production interference testing, the accumulated change in the strain data for the desired monitoring period may be determined and plotted on a waterfall plot, and the strain change peak locations may then be identified using the waterfall plot. Such strain change peak locations correspond to the measured depths of the fracture-driven interactions between the monitor well and the conducive fractures originating from the production well, where such fracture-driven interactions are represented by strain data that reveal a reaction to the closure and opening of the hydraulic fractures as a result of the production well alternating between being put on production (POP) and shut-in during the production interference testing. The strain change peak locations may then be plotted in time, and each strain change peak location may be correlated to the times at which the production well was put on production and shut-in to associate the conductive hydraulic fractures with one or more production wells. These associations may then be utilized, in combination with the measured depths of the wetted fracture hit locations (or fracture-driven interactions), to identify the originating stage for each conductive hydraulic fracture, as well as to determine the conductive fracture dimensions. Moreover, more generally speaking, temporal plots may be generated for each active measured depth along the monitor well, and the production well(s) that are reacting to each active measured depth during the production interference tests may then be determined based on the temporal plots, with or without the identification of the strain change peak locations.

In some embodiments, the information regarding the conductive fracture dimensions is used to determine the heterogeneity of the conductive fracture lengths and/or heights within and among stages, as well as between multiple production wells within the field. In various embodiments, such information may be used to modify, refine, and/or validate one or more well spacing and/or well stacking determinations for the field. In some embodiments, this may be accomplished, at least in part, by calibrating or updating one or more fracture simulation models and then utilizing such fracture simulation model(s) to optimize the well spacing and/or stacking parameters for the field. Additionally or alternatively, such information may be used to adjust parameters corresponding to the stimulation operation for any of the production wells within the field. As an example, if the conductive hydraulic fractures for a particular production well are shorter than expected, the pumping rate and/or volume for the fracturing fluid may be increased for such production well (and/or for similar production wells within the field). However, if the conductive hydraulic fractures for a particular production well are longer than expected, the pumping rate and/or volume for the fracturing fluid may be decreased for such production well (and/or for similar production wells within the field). Furthermore, in some embodiments, the determined information is used to monitor and adjust the parameters for the stimulation operation and/or the production operation with respect to any of the production wells in real-time as the field is being developed.

According to embodiments described herein, the strain data from the monitor well can be advantageously leveraged to determine the conductive fractures dimensions for multiple production wells, even in cases where the production wells interact with similar regions of the monitor well. Moreover, because the present disclosure can utilize strain data measured during any periods of production and shut-in, the present disclosure is compatible with production interference tests conducted at any point during the production operation with respect to each production well. Furthermore, under certain conditions, the present disclosure enables conductive fracture dimensions to be determined using only strain data measured during the production operation with respect to each production well (rather than relying on the utilization of strain data measured during the hydraulic fracturing operation as well). This is advantageous for situations where the production well has already been treated and, thus, strain data corresponding to the creation of the hydraulic fractures are not available.

In various embodiments, the monitor well(s) and the production well(s) are located within the same field (or adjacent fields). Moreover, in various embodiments, the monitor well(s) and the production well(s) are positioned such that fiber optic cable(s) installed within the wellbore(s) of the monitor well(s) are capable of detecting strain changes with respect to hydraulic fractures originating from the production well(s). Accordingly, the aspects and embodiments described herein can be advantageously applied to any hydraulic fracturing and/or production scenarios involving multiple hydrocarbon wells that are within relatively close proximity to each other.

At least one production well and monitor well pair is utilized to perform the aspects and embodiments described herein. However, in various embodiments, multiple production wells are considered along with one or more monitor wells. As described herein, while the production well(s) undergo treatment (i.e., hydraulic fracturing) and/or production, the passive, instrumented monitor well(s) measure strain data via the corresponding fiber optic cable(s).

Each monitor well may include any suitable type(s) of fiber optic cable(s), as long as such fiber optic cable(s) are configured to measure temporal, high-resolution distributed strain data. As a specific, non-limiting example, an exemplary monitor well may include a first single mode fiber that is monitored with Distributed Strain Sensing based on Rayleigh Frequency Shift (RFS-DSS), a second single mode fiber that is monitored with Distributed Acoustic Sensing (DAS), and a multimode fiber that is monitored with Distributed Temperature Sensing (DTS). In this example, RFS-DSS monitoring may be used to capture higher-resolution fracture-driven interactions than can be captured by only DAS monitoring in the event that multiple hydraulic fractures are generated from a given perforation cluster. Furthermore, the fiber optic cable(s) may be deployed in any suitable manner. As an example, in some embodiments, the fiber optic cable(s) are attached to the outside of the casing and cemented in place. As another example, in some embodiments, the fiber optic cable(s) are lowered into the casing during the measurement period.

In some embodiments, each monitor well is further equipped with one or more additional types of measurement systems or tools, including, for example, one or more pressure gauge arrays and/or one or more temperature gauge arrays. As an example, for embodiments in which the monitor wells are equipped with pressure and/or temperature gauge array(s), pressure and/or temperature data measured via such pressure and/or temperature gauge array(s), respectively, may be utilized to validate and/or augment the results obtained according to the present disclosure.

In preferred embodiments, the monitor well(s) employed according to the present disclosure include one or more slant monitor wells, which are drilled at an angle to the production well(s) and, thus, are capable of advantageously measuring strain data at a variety of distances from the production well(s). However, in some embodiments, the monitor well(s) additionally or alternatively include one or more vertical monitor wells or one or more horizontal monitor wells (or some combination thereof).

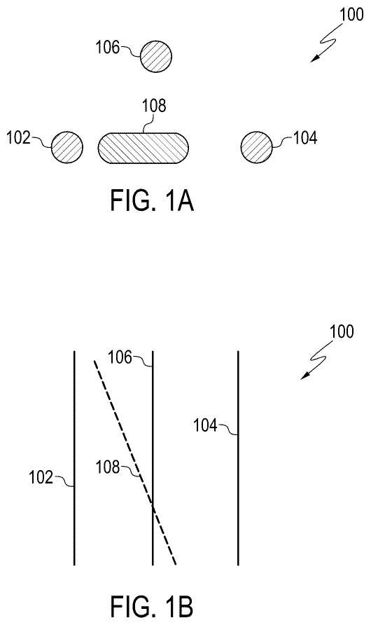

An exemplary configuration of the monitor and production wells is depicted in FIGS. 1A and 1B. Specifically, FIG. 1A is a schematic illustration of a gun barrel view of an exemplary field 100 for which the aspects and/or embodiments of the present disclosure may be employed, while FIG. 1B is schematic illustration of a plan view of the exemplary field 100 of FIG. 1A. In this simplified example, three production wells 102, 104, and 106 are depicted, along with a single monitor well 108. According to this example, the monitor well 108 is a slant well that is within close proximity to all three production wells 102, 104, and 106 and is capable of measuring strain data corresponding to stimulation and production operations for the production wells 102, 104, and 106, as described herein. In some embodiments, the monitor well 108 is at approximately the same landing depth as at least a portion of the production wells (e.g., in the example of FIG. 1B, the production wells 102 and 104) to facilitate the measurement of the conductive fracture dimensions.

In various embodiments, the location and orientation of the monitor well 108 with respect to each production well 102, 104, and 106, as well as the locations and orientations of the production wells 102, 104, and 106 with respect to each other, may cause interference issues when attempting to determine the origin of each fracture-driven interaction at the monitor well. However, the present disclosure advantageously utilizes strain data measured during production interference testing for each production well 102, 104, and 106 to effectively account for the effects of such interference and, therefore, decouple the results.

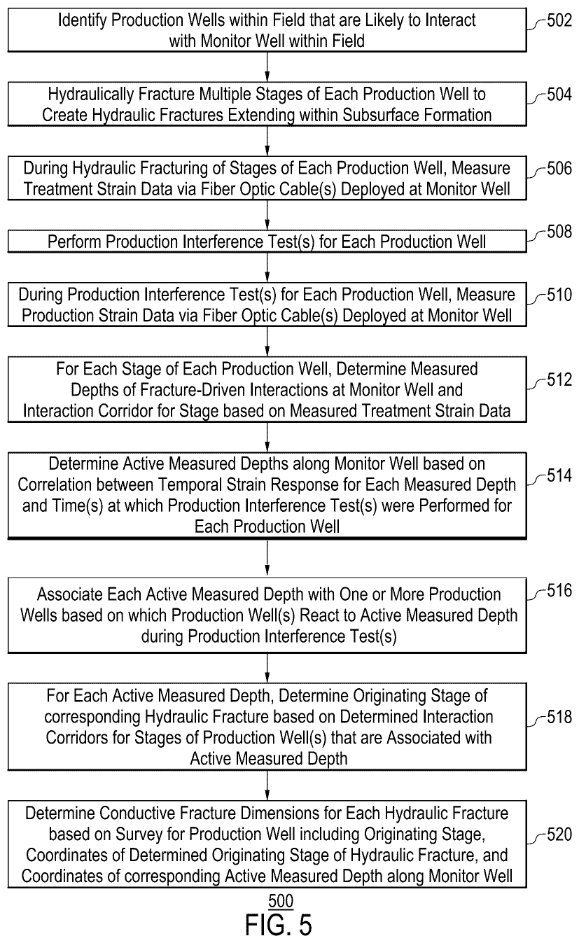

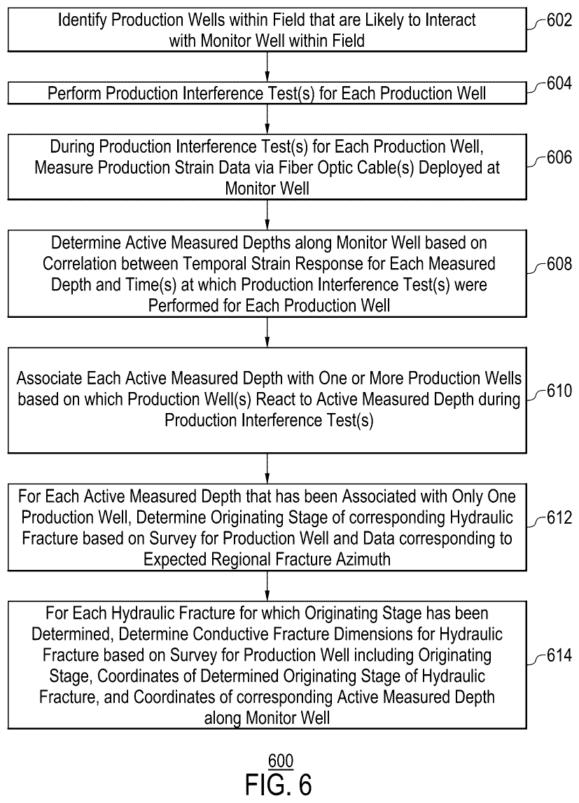

The aspects and embodiments provided by the present disclosure may be generally described in terms of two related processes that differ based on the degree of monitoring that is achieved. Specifically, the first process (which corresponds, at least in part, to the exemplary method 500 of FIG. 5) applies to scenarios in which the production well(s) are monitored via the optical fiber-equipped monitor well(s) during the treatment operation (i.e., during the stimulation of the various stages to create the hydraulic fractures), as well as during the production operation (i.e., in conjunction with production interference testing). This process results in the association of each conductive hydraulic fracture detected by the monitor well with a particular stage of a particular production well, as well as the determination of the dimensions (e.g., length, height, and/or azimuth) of each conductive hydraulic fracture. In contrast, the second process (which corresponds, at least in part, to the exemplary method 600 of FIG. 6) applies to scenarios in which the production well(s) are monitored via the fiber-equipped monitor well(s) during the production operation (i.e., in conjunction with production interference testing), but not during the treatment operation. According to this process, the stage origins and dimensions of the conductive hydraulic fractures can be determined for locations of the monitor well that are only hydraulically connected to a single production well. Moreover, in some cases, the stage origins and dimensions of the conductive hydraulic fractures can also be determined for locations of the monitor well that are hydraulically connected to multiple production wells via the utilization of additional data and/or user expertise, for example.

In the paragraphs that follow, the two processes are described with reference to a field including a single monitor well and multiple production wells. However, this is for case of discussion only, as the processes may also be performed for a field including more than one monitor well. In some cases, the processes may also be performed for a field including only a single production well. In addition, while the two processes are described below with reference to a number of ordered steps, the processes are not limited to the steps shown. Specifically, any number of steps may be omitted from either (or both) of the processes, and/or any number of new steps may be added to either (or both) of the processes, depending on the details of the particular implementation. Moreover, the numbering of the steps (e.g., as the first step, the second step, the third step, etc.) is for case of discussion only and is not intended to indicate that the steps must always be performed in the exact order given. Instead, the ordering of the steps may be susceptible to modification in some cases.

Turning now to a detailed description of an exemplary implementation of the first process (i.e., the process that utilizes strain data measured during both treatment and production), the following steps may be performed for the fiber-equipped monitor well (or for two or more, or each, fiber-equipped monitor well(s) in embodiments including multiple monitor wells). In the first step, production wells that are expected to interact with the monitor well are identified. This may include, for example, identifying production wells that are drilled proximate to the monitor well, such as, for example, at most around 500 feet to around 3000 feet, such as at most around 1,000 feet or at most around 2,000 feet from the monitor well. Additionally or alternatively, this may include utilizing one or more fracture simulation models for the field (and/or for similar fields) to predict the productions wells that are likely to interact with the monitor well. Furthermore, once the production wells have been identified, the fiber optic cable(s) at the monitor well are utilized to measure strain data corresponding to the treatment of each production well (which may be referred to hereinafter as “treatment strain data” for ease of discussion), as well as strain data corresponding to production interference testing for each production well (which may be referred to hereinafter as “production strain data” for ease of discussion). In particular, the treatment strain data are measured during the hydraulic fracturing of the stages of each production well. The production strain data are measured during one or more production interference tests for each production well, where each production interference test includes at least one instance of the production well being put on production or shut-in (either specifically for production interference testing purposes or as a routine part of the production operation).

In the second step of the process, the measured treatment strain data corresponding to each production well are utilized to determine the measured depths (MDs) of the fracture-driven interactions (or wetted fracture hits) at the monitor well for each treated stage of the production well. In various embodiments, this is accomplished by generating a waterfall plot from the treatment strain data for each treated stage of each production well, where such waterfall plot represents the temporal strain rate changes within the treatment strain data along the length of the monitor well. The measured depths of the fracture-driven interactions are then determined by identifying the measured depths within the waterfall plot at which characteristic fracture opening-and-closing signatures are revealed by the strain rate changes within the treatment strain data. Such characteristic fracture opening-and-closing signatures include positive tensile strain rate changes during treatment and compressive strain rate changes after pumping has ceased (i.e., due to pressure drawdown inside the hydraulic fractures). In addition, for each treated stage of the production well, the interaction corridor (which includes the range of measured depths along the monitor well at which the fracture-driven interactions occur) is quantified with respect to the monitor well. In various embodiments, this includes specifying the interaction corridor for a particular stage as extending from the measured depth of the shallowest wetted fracture hit for the stage to the measured depth of the deepest wetted fracture hit for the stage.

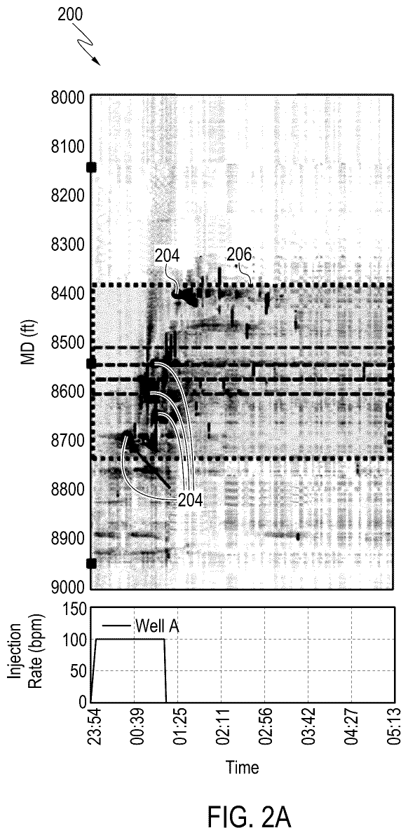

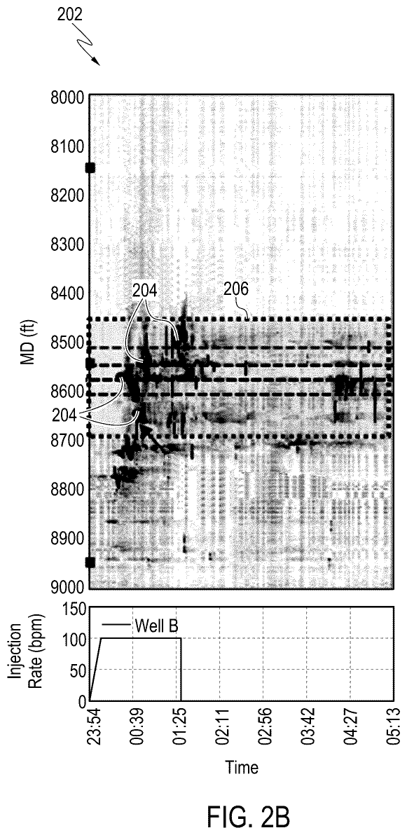

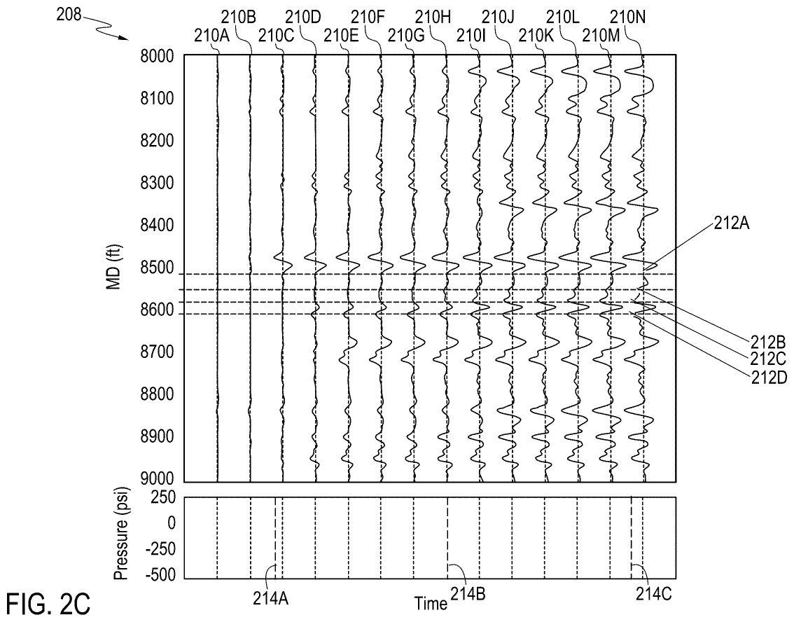

This step is illustrated, at least in part, by the exemplary implementation represented by FIGS. 2A and 2B. Specifically, FIG. 2A is a first waterfall plot 200 corresponding to the treatment strain data for a first production well (Well A), and FIG. 2B is a second waterfall plot 202 corresponding to the treatment strain data for a second production well (Well B). The first and second waterfall plots 200 and 202 depict the strain rate change within the treatment strain data for each respective production well as a function of time and measured depth (in feet) along the monitor well. As shown in FIGS. 2A and 2B, a number of fracture-driven interactions 204 are identified for each production well, where each fracture-driven interaction correlates to a particular measured depth along the monitor well. In addition, interaction corridors 206 are determined for each production well, where each interaction corridor 206 corresponds to a particular measured depth range along the monitor well, as shown in FIGS. 2A and 2B. Furthermore, along the bottom of each waterfall plot 200 and 202, the injection rate (in barrels per minute) for the stage of the respective production well is plotted as a function of time, thus correlating the time at which the treatment actually occurs with the treatment strain data depicted in the waterfall plots 200 and 202, respectively.

It should be noted that, while strain rate changes are described with respect to fiber data measured during treatment and strain changes are described with respect to fiber data measured during production, embodiments described herein are not limited by this description. Specifically, strain rate changes, strain changes, and/or any other suitable type(s) of distributed measurements can be used during treatment and/or production. As a non-limiting example, in some embodiments, pressure fiber cables may be used to measure pressure changes, rather than strain changes, during treatment and/or production.

Turning now to the third step of the process, a waterfall plot is generated from the cumulative production strain data from the production interference testing for the production wells. Such waterfall plot represents the temporal strain changes within the production strain data along the length of the monitor well, where the term “strain change” in this context refers to the accumulated strain relative to a baseline strain measurement. In general, negative strain changes (which correspond to compressive stress) are expected when an interacting production well is put on production during a production interference test. This is due to the fact that the hydraulic fractures close (or at least partially close) during depletion. On the contrary, positive strain changes (which correspond to tensile stress) are expected when an interacting production well is shut-in during a production interference test. This is due to the fact that the hydraulic fractures expand during pressure build-up.

In the fourth step of the process, strain change curves are fitted to the temporal strain changes within the waterfall plot for various time instances covering the entire monitoring period for the production interference testing. This results in the generation of a number of strain change curves on the waterfall plot, where each strain change curve corresponds to a specific time instance during the monitoring period corresponding to the production interference testing for the production wells within the field. One strain change curve is then selected for consideration. In preferred embodiments, the strain change curve that is measured latest in time (i.e., closest to the end of the monitoring period) is selected for consideration (since the latest-in-time strain change curve generally corresponds to the production strain data incorporating the largest extent of hydraulic fracture propagation). However, in other embodiments, a different strain change curve may be selected, depending on the details of the particular implementation. Moreover, once the strain change curve has been selected, the measured depths at which the strain change value peaks along the selected strain change curve (which is referred to herein as the “strain change peak locations”) are identified. Each strain change peak location represents a fracture-driven interaction (or wetted fracture hit) between the monitor well and the conducive fractures originating from the production well, as determined by the corresponding production strain data that reveal a reaction to the closure and/or opening of the hydraulic fractures as a result of the production well alternating between being put on production and/or shut-in during the production interference testing. Moreover, each strain change peak location is correlated to the measured depth of at least one of the fracture-driven interactions from the second step of the process.

The third and fourth steps are illustrated, at least in part, by the exemplary implementation represented by FIG. 2C. Specifically, FIG. 2C is a third waterfall plot 208 corresponding to production strain data for both production wells (Well A and Well B), as well as a third production well within the field (Well C). Specifically, a number of strain change curves 210A, 210B, 210C, 210D, 210E, 210F, 210G, 210H, 210I, 210J, 210K, 210L, 210M, and 210N have been fitted to the temporal strain changes within the production strain data that are plotted on the waterfall plot 208. The latest-in-time strain change curve, i.e., the strain change curve 210N, has been selected for consideration, and a number of strain change peak locations 212A, 212B, 212C, and 212D have been determined along the strain change curve 210N, as shown in FIG. 2C. As also shown in FIG. 2C, each strain change peak location 212 can generally be correlated to at least one of the fracture-driven interactions 204 within the first or second waterfall plot 200 and/or 202, respectively. Moreover, along the bottom of the third waterfall plot 208, a first time 214A at which the first production well (Well A) was put on production, a second time 214B at which the third production well (Well C) was put on production, and a third time 214C at which the second production well (Well B) was put on production are plotted.

In the fifth step of the process, the temporal strain response for each strain change peak location is plotted, and the resulting plot is utilized to differentiate between strain change peak locations corresponding to the measured depths of active hydraulic fractures (referred to herein as “active measured depths” for ease of discussion) and strain change peak locations corresponding to the measured depths of inactive hydraulic fractures (referred to herein as “inactive measured depths” for case of discussion). As described herein, the term “active” is used with reference to hydraulic fractures that maintain enough hydraulic conductivity to elicit a response at the monitor well, where such hydraulic fractures may be identified based on the strain response that is generated at the corresponding measured depth when one of the production wells is either put on production or shut-in during production interference testing. In contrast, the term “inactive” is used with reference to hydraulic fractures that have either lost sufficient hydraulic conductivity to elicit a response at the monitor well or were attributable to noise within the production strain data, where such hydraulic fractures may be identified based on a plateaued strain response and/or a strain response that does not correlate to the time at which any of the production wells were put on production or shut-in. Therefore, the output of the fifth step includes one or more active measured depths that are to be considered during the next step of the process, with one or more inactive measured depths being removed from further consideration. In addition, as part of the fifth step, each active measured depth (or at least a subset thereof) is linked to (or associated with) one or more potential originating productions well based on the temporal strain response curves as compared to the times at which the production wells were put on production and/or shut-in.

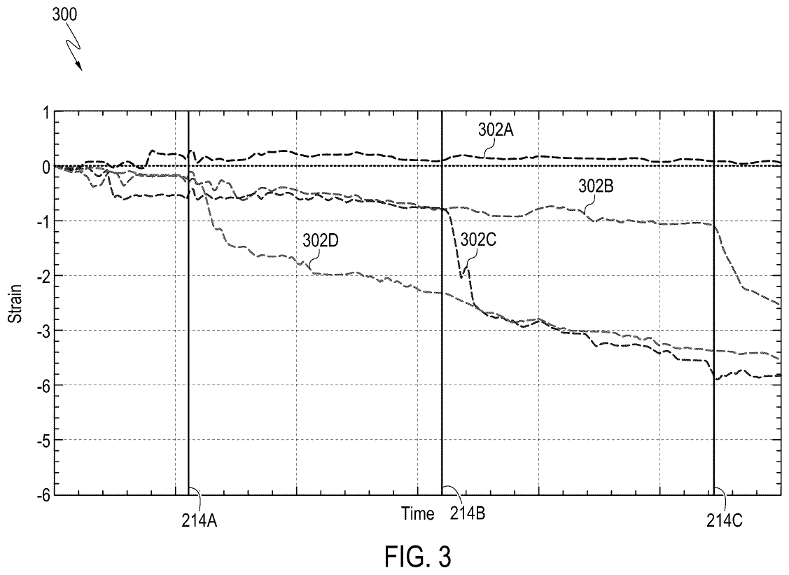

This is illustrated by the exemplary implementation represented by FIG. 3. Specifically, FIG. 3 is a plot 300 of the strain response as a function of time at the measured depths corresponding to each of the strain change peak locations 212A, 212B, 212C, and 212D from FIG. 2C, where the strain response is measured for the duration of a production interference test. Specifically, a first temporal strain response curve 302A corresponds to the first strain change peak location 212A, a second temporal strain response curve 302B corresponds to the second strain change peak location 212B, a third temporal strain response curve 302C corresponds to the third strain change peak location 212C, and a fourth temporal strain response curve 302D corresponds to the fourth strain change peak location 212D. In addition, the plot 300 includes the visualization of the first time 214A at which the first production well (Well A) was put on production, the second time 214B at which the third production well (Well C) was put on production, and the third time 214C at which the second production well (Well B) was put on production, as described with respect to FIG. 2C.

Based on the strain responses shown in FIG. 2C, it is clear that the first strain change peak location 212A, which is represented by the first temporal strain response curve 302A, can be classified as an inactive measured depth that is attributable to noise within the production strain data and, therefore, may be disregarded. The second strain change peak location 212B, which is represented by the second temporal strain response curve 302B, can be classified as an active measured depth that is attributable to the first production well (Well A) being put on production at the first time 214A and the second production well (Well B) being put on production at the third time 214C. The third strain change peak location 212C, which is represented by the third temporal strain response curve 302C, can be classified as an active measured depth that is attributable to the third production well (Well C) being put on production at the second time 214B. In addition, the fourth strain change peak location 212D, which is represented by the fourth temporal strain response curve 302d, can be classified as an active measured depth that is attributable to the first production well (Well A) being put on production at the first time 214A.

In the sixth step of the process, the originating stage of the hydraulic fracture corresponding to each active measured depth is determined. For active measured depths that have been linked to one or more productions well that were monitored during treatment, this may be accomplished by utilizing the determined interaction corridor for each linked production well to determine the most likely originating stage corresponding to each active measured depth. Moreover, for any active measured depths that have been linked to one or more production wells that were not monitored during treatment, the corresponding originating stages can be predicted using surveys corresponding to the production wells, as well as data corresponding to an expected regional fracture azimuth; however, in this case, the originating stages can only be conclusively assigned for any active measured depths that show a strain response to only a single production well.

In some cases, one or more of the active measured depths may not correlate to the interaction corridor of any linked production well. In this case, the hydraulic connection is likely established through the hydraulic fractures of another, intervening production well, which may be referred to herein as a “conduit production well.” In this case, the conduit production well can be identified by tracking which additional production well is connected to that location and has also generated wetted fracture hits. However, if more than one production well meets those conditions, the conduit production well may not be conclusively determined.

Finally, in the seventh step of the process, the conductive hydraulic fracture dimensions corresponding to each active measured depth are determined based, at least in part, on data corresponding to the associated originating production well and stage. For each conductive hydraulic fracture of interest, this may be accomplished, at least in part, by utilizing the corresponding production well survey in combination with the coordinates of the associated originating stage and the interacting active measured depth along the monitor well. In various embodiments, this includes determining the height, length, and/or azimuth of each conductive hydraulic fracture by calculating the vertical and/or horizontal distance between the originating stage and the interacting active measured depth along the monitor well. In addition, in some embodiments, the wetted hydraulic fracture dimensions are determined using the same approach, enabling the estimation of conductive/wetted fracture count ratios, for example. Furthermore, any number of other relevant fracture characteristics may be determined according to the present disclosure, such as, for example, fracture growth rate, cluster efficiency, vertical connectivity, total number of wetted fracture hits per stage, three-dimensional fracture morphology, relative fracture density, and like.

Moreover, it should be noted that the first process is described above with respect to the utilization of strain change peak locations. However, as described herein, the process can alternatively be performed by generating temporal plots for each active measured depth along the monitor well and then determining which production well(s) are reacting to each active measured depth during the production interference tests, without the identification of the strain change peak locations. This is described further with respect to the method 500 of FIG. 5.

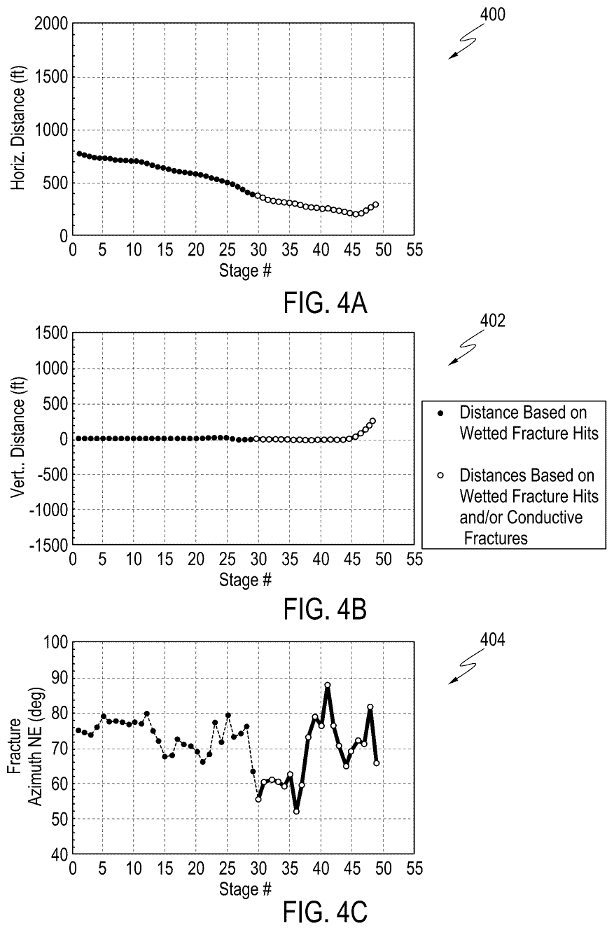

The results of this step are illustrated, at least in part, by the exemplary implementation represented by FIGS. 4A, 4B, and 4C, which depicts exemplary information that may be obtained for a production well and monitor well pair according to embodiments described herein. Specifically, FIG. 4A is a first plot 400 of horizontal distance (in feet) between each stage of the treatment well and the interacting active measured depths on the monitor well; FIG. 4B is a second plot 402 of vertical distance (in feet) between each stage of the treatment well and the interacting active measured depths on the monitor well; and FIG. 4C is a third plot 404 of the calculated fracture azimuths (in degrees) for the stages of the treatment well. Moreover, as shown by the legend in the figures, the horizontal distance, vertical distance, and fracture azimuths are calculated based on both the distances for the wetted fracture hits and the distances for the wetted fracture hits and/or the conductive fractures.

Turning now to a detailed description of an exemplary implementation of the second process (i.e., the process that utilizes only strain data measured during production), the following steps may be performed for the fiber-equipped monitor well (or for each fiber-equipped monitor well in embodiments including multiple monitor wells). In the first step of the second process, production wells that are expected to interact with the monitor well are identified (as described with respect to the first step of the first process), and production strain data are measured during production interference testing for each identified production well. In the second step, production interference test(s) are performed for each production well. In the third step, during the production interference test(s) for each production well, production strain data are measured via fiber optic cable(s) deployed at the monitor well. In the fourth step, active measured depths along the monitor well are determined based on the correlation between the temporal strain response for each measured depth (as determined by the measured production strain data) and the time(s) at which the production interference test(s) were performed for each production well. In the fifth step, each active measured depth is associated with one or more production wells based on which production well(s) reacted to the active measured depth during the production interference test(s). In the sixth step, for each active measured depth that has been associated with only one production well, the originating stage of the corresponding hydraulic fractures is determined. Specifically, the originating stages may be predicted using production well surveys in combination with data corresponding to an expected regional fracture azimuth. However, due to the likely inability to rule out interference without the utilization of treatment strain data, the originating stages may only be conclusively assigned for any active measured depths that show a production strain response to only a single production well. Finally, in the seventh step, for each hydraulic fracture that corresponds to an active measured depth that was correlated to an originating stage during the sixth step of the process, conductive fracture dimensions are determined for the hydraulic fracture based on the production well survey for the corresponding production well, the coordinates of the determined originating stage of the hydraulic fracture, and the coordinates of the corresponding active measured depth along the monitor well. This results in the output of the originating stages and dimensions for at least a portion of the hydraulic fractures corresponding to the identified active measured depths.

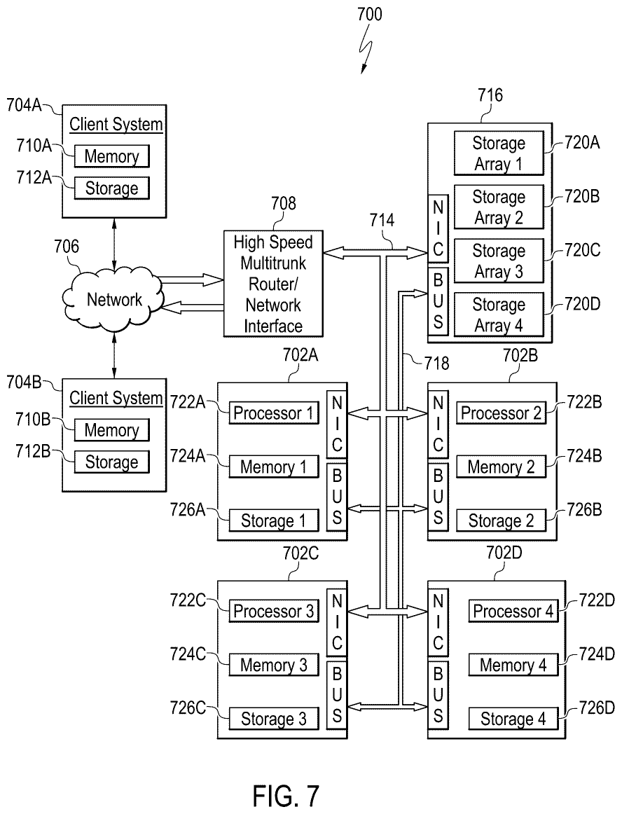

FIG. 5 is a process flow diagram of an exemplary method 500 for determining conductive fracture characteristics for one or more production wells using strain data measured via a fiber-equipped monitor well during treatment and production via the production well(s), in accordance with the present disclosure. In various embodiments, the method 500 of FIG. 5 correlates to the first process described above (or any suitable variation thereof). The method 500 may be executed, at least in part, by one or more computing systems including one or more processors, such as the exemplary cluster computing system described with respect to FIG. 7 (or any suitable variation(s) thereof). In various embodiments, such computing system(s) are positioned at the hydrocarbon field at which the production wells and the monitor well(s) are located and form part of the overall hydrocarbon well system. For example, the computing system(s) may form part of a mobile command center for directing the operations performed with respect to such wells.

The method 500 begins at block 502 with the identification of production wells within a field that are likely to interact with a monitor well within the same field (or an adjacent/adjoining field). In some embodiments, this includes identifying production wells that are within a specified distance from the monitor well, such as, for example, at most around 1,000 feet or at most around 2,000 feet from the monitor well. Additionally or alternatively, in some embodiments, this includes utilizing one or more fracture simulation models for the field (and/or for similar fields) to predict the productions wells that are likely to interact with the monitor well. As a specific example, if the fracture simulation model(s) predict that the likelihood of a particular production well interacting with the monitor well is greater than or equal to 50%, the production well may be selected at block 502. Moreover, it should be noted that the term “interaction” in this context refers to a subsurface interaction between the two wells that can be detected via one or more fiber optic cables.

At block 504, multiple stages of each production well are hydraulically fractured to create hydraulic fractures extending within the subsurface formation corresponding to the field. At block 506, treatment strain data are measured via one or more fiber optic cables deployed at the monitor well during the hydraulic fracturing of the stages of each production well.

At block 508, one or more production interference tests are performed for each production well. At block 510, production strain data are measured via the fiber optic cable(s) deployed at the monitor well during the production interference test(s) for each production well.

At block 512, for each stage of each production well, the measured depths of the fracture-driven interactions at the monitor well, as well as the interaction corridor for the stage, are determined based on the measured treatment strain data. In various embodiments, this includes performing the following for each stage: (a) generating a waterfall plot from the treatment strain data for the stage, where the waterfall plot includes temporal strain rate changes within the treatment strain data along the length of the monitor well; (b) identifying measured depths within the waterfall plot at which characteristic fracture opening-and-closing signatures are revealed by the temporal strain rate changes and assigning the identified measured depths as the measured depths of the fracture-driven interactions; and (c) specifying the interaction corridor for the stage based on the range of the measured depths of the fracture-driven interactions for the stage.

At block 514, the active measured depths along the monitor wells are determined based on the correlation between the temporal strain response for each measured depth and the time(s) at which the production interference test(s) were performed for each production wells. In various embodiments, the temporal strain response is determined by generating temporal plots for each active measured depth. In some embodiments, block 514 includes determining strain change peak locations along the monitor well based on temporal strain changes within the production strain data, where each strain change peak location corresponds to one of the determined measured depths from block 512. In such embodiments, this may include performing the following: (a) generating a waterfall plot from the production strain data for the production wells, where the waterfall plot includes temporal strain changes within the production strain data along the length of the monitor well; (b) fitting strain change curves to the temporal strain changes within the waterfall plot for various time instances covering the monitoring period for the production interference tests for the production wells; (c) selecting one of the strain change curves; and (d) identifying strain change peak locations within the selected one of the strain change curves. Moreover, in some such embodiments, selecting one of the strain change curves includes selecting the latest-in-time strain change curve.

At block 516, each active measured depth is then associated with one or more production wells based on which production well(s) react to the active measured depth during the production interference test(s). In some embodiments, this association is determined based on a comparison between the temporal strain response for each strain change peak location and the time(s) at which the production interference test(s) were performed for each production well. In such embodiments, this may include performing the following for the measured depths that correspond to the determined strain change peak locations from block 514: (a) plotting the temporal strain response corresponding to each strain change peak location as a function of time; (b) plotting the time(s) at which the production interference test(s) were performed for each production well; (c) for each strain change peak location, determining whether the temporal strain response corresponding to the strain change peak location correlates to the time at which a production interference test was performed for at least one of the production wells; and (d) for each strain change peak location including the temporal strain response that correlates to the time at which the production interference test was performed for at least one of the production wells, assigning the measured depth corresponding to the strain change peak location as one of the identified active measured depths.

At block 518, for each active measured depth that was identified at block 516, the originating stage of the corresponding hydraulic fracture is determined based on the determined interaction corridors for the stages of the production well(s) that are associated with the active measured depth. In various embodiments, the method 500 further includes, for instances in which the active measured depth does not correlate to any of the determined interaction corridors for the stages of the production well(s) that have been associated with the active measured depth, identifying a conduit production well through which a hydraulic connection is established with the monitor well, as described herein.

At block 520, conductive fracture dimensions are determined for each hydraulic fracture based on a survey for the production well that includes the originating stage, the coordinates of the determined originating stage of the hydraulic fracture, and the coordinates of the corresponding active measured depth along the monitor well. In various embodiments, this includes determining the fracture height, fracture length, and/or fracture azimuth for each hydraulic fracture, although other fracture characteristics may also be determined in some embodiments.

Those skilled in the art will appreciate that the exemplary method 500 of FIG. 5 is susceptible to modification without altering the technical effect provided by the present disclosure. In practice, the exact manner in which the method 500 is implemented will depend, at least in part, on the details of the specific implementation. For example, in some embodiments, some of the blocks shown in FIG. 5 may be altered or omitted from the method 500 and/or new blocks may be added to the method 500, without departing from the scope of the present disclosure.

FIG. 6 is a process flow diagram of an exemplary method 600 for determining conductive fracture characteristics for one or more production wells using strain data measured via a fiber-equipped monitor well during production via the production well(s), in accordance with the present disclosure. In various embodiments, the method 600 of FIG. 6 correlates to the second process described above (or any suitable variation thereof). The method 600 may be executed, at least in part, by one or more computing systems including one or more processors, such as the exemplary cluster computing system described with respect to FIG. 7 (or any suitable variation(s) thereof). In various embodiments, such computing system(s) are positioned at the hydrocarbon field at which the production wells and the monitor well(s) are located and form part of the overall hydrocarbon well system. For example, the computing system(s) may form part of a mobile command center for directing the operations performed with respect to such wells.

The method 600 begins at block 602 with the identification of production wells within a field that are likely to interact with a monitor well within the same field (or an adjacent/adjoining field). In some embodiments, this includes identifying production wells that are within a specified distance from the monitor well, such as, for example, at most around 1,000 feet or at most around 2,000 feet from the monitor well. Additionally or alternatively, in some embodiments, this includes utilizing one or more fracture simulation models for the field (and/or for similar fields) to predict the productions wells that are likely to interact with the monitor well. As a specific example, if the fracture simulation model(s) predict that the likelihood of a particular production well interacting with the monitor well is greater than or equal to 50%, the production well may be selected at block 602.

At block 604, one or more production interference test(s) are performed for each production well. At block 606, production strain data are measured via the fiber optic cable(s) deployed at the monitor well during the production interference test(s) for each production well.

At block 608, active measured depths along the monitor well are determined based on the correlation between the temporal strain response for each measured depth and the time(s) at which the production interference test(s) were performed for each production well. At block 610, each active measured depth is associated with one or more production wells based on which production well(s) react to the active measured depth during production interference test(s).

At block 612, for each active measured depth that has been associated with only one of the production wells, the originating stage of the corresponding hydraulic fracture is determined based on the survey for the production well in combination with data corresponding to the expected regional fracture azimuth. Moreover, at block 614, for each hydraulic fracture for which the originating stage has been determined, conductive fracture dimensions for the hydraulic fracture are determined based on the survey for the production well, the coordinates of the determined originating stage of the hydraulic fracture, and the coordinates of the corresponding active measured depth along the monitor well. In various embodiments, this includes determining the fracture height, fracture length, and/or fracture azimuth for each hydraulic fracture, although other fracture characteristics may also be determined in some embodiments.

Those skilled in the art will appreciate that the exemplary method 600 of FIG. 6 is susceptible to modification without altering the technical effect provided by the present disclosure. In practice, the exact manner in which the method 600 is implemented will depend, at least in part, on the details of the specific implementation. For example, in some embodiments, some of the blocks shown in FIG. 6 may be altered or omitted from the method 600 and/or new blocks may be added to the method 600, without departing from the scope of the present disclosure.

In various embodiments, the method 500 of FIG. 5 and/or the method 600 of FIG. 6 also includes developing/modifying and executing a suitable well spacing and/or well stacking plan for the field based on the data corresponding to the conductive fracture dimensions for the production wells. This may include, for example, advantageously minimizing the number of wells to be drilled within the field to avoid unnecessarily high costs, as well as preventing the under-development of the field, which often results in stranded resources. Additionally or alternatively, in various embodiments, the method 500 of FIG. 5 and/or the method 600 of FIG. 6 also includes adjusting the stimulation operation for the production wells within the field based on the data corresponding to the conductive fracture dimensions for the production wells. This may include, for example, ensuring that the treatment schedules are customized based on the expected conductive fracture dimensions. Additionally or alternatively, in various embodiments, the method 500 of FIG. 5 and/or the method 600 of FIG. 6 also includes calibrating or updating one or more fracture simulation models based on the data corresponding to the conductive fracture dimensions, as well as applying such fracture simulation model(s) to the field in various ways, such as, for example, by optimizing the well spacing parameters, well stacking parameters, treatment parameters, and/or production parameters for the production wells within the field.

In various embodiments, any of the methods/processes described herein (or at least a portion of such methods/processes) may be partially or fully automated via integration into a diagnostic tool that is capable of assimilating large amounts of data and providing customized outputs that are specific to the production wells within the particular field. In some such embodiments, the diagnostic tool may also be capable of providing automatic recommendations for adjustments to well spacing, well stacking, and/or stimulation parameters for the field. For embodiments in which the computing system(s) hosting the diagnostic tool form part of the overall hydrocarbon well system within the field, the diagnostic tool may be further capable of automatically implementing (or directing the implementation of) at least a portion of such recommendations.

FIG. 7 is a block diagram of an exemplary cluster computing system 700 that may be utilized to implement at least a portion of the aspects and/or embodiments provided by the present disclosure. The exemplary cluster computing system 700 shown in FIG. 7 has four computing units 702A, 702B, 702C, and 702D, each of which may perform calculations for a portion of the aspects and embodiments provided by the present disclosure. However, one of ordinary skill in the art will recognize that the cluster computing system 700 is not limited to this configuration, as any number of computing configurations may be selected. For example, a smaller analysis may be run on a single computing unit, such as a workstation, while a large calculation may be run on a cluster computing system 700 having tens, hundreds, or even more computing units.

The cluster computing system 700 may be accessed from any number of client systems 704A and 704B over a network 706, for example, through a high-speed network interface 708. The computing units 702A to 702D may also function as client systems, providing both local computing support and access to the wider cluster computing system 700.

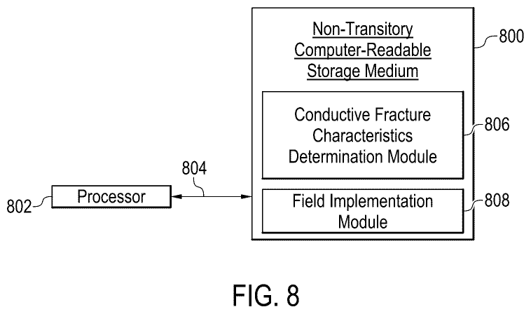

The network 706 may include a local area network (LAN), a wide area network (WAN), the Internet, or any combinations thereof. Each client system 704A and 704B may include one or more non-transitory, computer-readable storage media for storing the operating code and program instructions that are used to implement at least a portion of the aspects and/or embodiments provided by the present disclosure, as described further with respect to the non-transitory, computer-readable storage media of FIG. 8. For example, each client system 704A and 704B may include a memory device 710A and 710B, which may include random access memory (RAM), read only memory (ROM), and the like. Each client system 704A and 704B may also include a storage device 712A and 712B, which may include any number of hard drives, optical drives, flash drives, or the like.

The high-speed network interface 708 may be coupled to one or more buses in the cluster computing system 700, such as a communications bus 714. The communication bus 714 may be used to communicate instructions and data from the high-speed network interface 708 to a cluster storage system 716 and to each of the computing units 702A to 702D in the cluster computing system 700. The communications bus 714 may also be used for communications among the computing units 702A to 702D and the cluster storage system 716. In addition to the communications bus 714, a high-speed bus 718 can be present to increase the communications rate between the computing units 702A to 702D and/or the cluster storage system 716.

In some embodiments, the one or more non-transitory, computer-readable storage media of the cluster storage system 716 include storage arrays 720A, 720B, 720C and 720D for the storage of models, data. visual representations, results (such as graphs, charts, and the like used to convey results obtained using the processes described herein), code, and other information concerning the implementation of at least a portion of the aspects and/or embodiments provided by the present disclosure. The storage arrays 720A to 720D may include any combinations of hard drives, optical drives, flash drives, or the like.

Each computing unit 702A to 702D includes at least one processor 722A, 722B, 722C and 722D and associated local non-transitory, computer-readable storage media, such as a memory device 724A, 724B, 724C and 724D and a storage device 726A, 726B, 726C and 726D, for example. Each processor 722A to 722D may be a multiple core unit, such as a multiple core central processing unit (CPU) or a graphics processing unit (GPU). Each memory device 724A to 724D may include ROM and/or RAM used to store program instructions for directing the corresponding processor 722A to 722D to implement at least a portion of the aspects and/or embodiments provided by the present disclosure. Each storage device 726A to 726D may include one or more hard drives, optical drives, flash drives, or the like. In addition, each storage device 726A to 726D may be used to provide storage for models, intermediate results, data, images, or code used to implement at least a portion of the aspects and/or embodiments provided by the present disclosure.

The present disclosure is not limited to the architecture or unit configuration illustrated in FIG. 7. For example, any suitable processor-based device may be utilized for implementing at least a portion of the embodiments described herein, including (without limitation) personal computers, laptop computers, computer workstations, mobile devices, and multi-processor servers or workstations with (or without) shared memory. Moreover, the embodiments described herein may be implemented, at least in part, on application specific integrated circuits (ASICs) or very-large-scale integrated (VLSI) circuits. In fact, those skilled in the art may utilize any number of suitable structures capable of executing logical operations according to the embodiments described herein.

FIG. 8 is a block diagram of an exemplary non-transitory, computer-readable storage medium 800 that may be used for the storage of data and modules of program instructions for implementing at least a portion of the aspects and/or embodiments provided by the present disclosure. The non-transitory, computer-readable storage medium 800 may include a memory device, a hard disk, and/or any number of other devices, as described herein. A processor 802 may access the non-transitory, computer-readable storage medium 800 over a bus or network 804. While the non-transitory, computer-readable storage medium 800 may include any number of modules for implementing the aspects and embodiments provided by the present disclosure, in some embodiments, the non-transitory, computer-readable storage medium 800 includes a conductive fracture characteristics determination module 806 for determining the originating stages and/or dimensions of conductive fractures created with respect to production wells according to embodiments described herein, as well as an optional field implementation module 808 for modifying one or more operations with respect to the field of interest based on the output from the conductive fracture characteristics determination module 806, as described herein.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present disclosure includes all alternatives, modifications, and equivalents falling within the true spirit and scope of the appended claims.

What is claimed is:

1. A method for determining conductive fracture dimensions for production wells within a field, comprising:
identifying production wells within a field that are likely to interact with a monitor well within the field;
hydraulically fracturing multiple stages of each production well to create hydraulic fractures extending within a subsurface formation;
during the hydraulic fracturing of the stages of each production well, measuring treatment strain data via a fiber optic cable deployed at the monitor well;
performing a production interference test for each production well;
during the production interference test for each production well, measuring production strain data via the fiber optic cable deployed at the monitor well;
for each stage of each production well, determining measured depths of fracture-driven interactions at the monitor well and an interaction corridor for the stage based on the measured treatment strain data;
determining active measured depths along the monitor well based on a correlation between a temporal strain response for each measured depth and a time at which the production interference test was performed for each production well;
associating each active measured depth with one or more production wells based on which of the production wells reacted to the active measured depth during the corresponding production interference test;
for each active measured depth, determining an originating stage of a corresponding hydraulic fracture based on the determined interaction corridors for the stages of the one or more production wells that are associated with the active measured depth; and
determining conductive fracture dimensions for each hydraulic fracture based on a survey for the production well comprising the originating stage, coordinates of the determined originating stage of the hydraulic fracture, and coordinates of the corresponding active measured depth along the monitor well.

2. The method of claim 1, comprising, for each stage of each production well, determining the measured depths of the fracture-driven interactions at the monitor well and the interaction corridor for the stage based on the measured treatment strain data by:
generating a waterfall plot from the treatment strain data for the stage, wherein the waterfall plot comprises temporal strain rate changes within the treatment strain data along a length of the monitor well;
identifying measured depths within the waterfall plot at which characteristic fracture opening-and-closing signatures are revealed by the temporal strain rate changes and assigning the identified measured depths as the measured depths of the fracture-driven interactions; and
specifying the interaction corridor for the stage based on the range of the measured depths of the fracture-driven interactions for the stage.

3. The method of claim 1, wherein determining the active measured depths along the monitor well based on the correlation between a temporal strain response for each measured depth and the time at which the production interference test was performed for each production well comprises determining strain change peak locations along the monitor well based on temporal strain changes within the production strain data, wherein each strain change peak location corresponds to one of the determined measured depths.

4. The method of claim 3, comprising determining the strain change peak locations along the monitor well based on the temporal strain changes within the production strain data by:
generating a waterfall plot from the production strain data for the production wells, wherein the waterfall plot comprises temporal strain changes within the production strain data along a length of the monitor well;
fitting strain change curves to the temporal strain changes within the waterfall plot for various time instances covering a monitoring period for the production interference tests for the production wells;
selecting one of the strain change curves; and
identifying strain change peak locations within the selected one of the strain change curves.

5. The method of claim 4, wherein selecting one of the strain change curves comprises selecting a latest-in-time strain change curve.

6. The method of claim 1, wherein determining the originating stage of the corresponding hydraulic fracture for each active measured depth based on the determined interaction corridors for the stages of the one or more production wells that has been associated with the active measured depth further comprises, for instances in which the active measured depth does not correlate to any of the determined interaction corridors for the stages of the one or more production wells that has been associated with the active measured depth, identifying a conduit production well through which a hydraulic connection is established with the monitor well.

7. The method of claim 1, wherein determining the conductive fracture dimensions for each hydraulic fracture comprises determining at least one of a fracture height, a fracture length, and a fracture azimuth.

8. The method of claim 1, further comprising modifying and executing at least one of a well spacing plan and a well stacking plan for the field based on the determined conductive fracture dimensions.

9. The method of claim 1, further comprising adjusting a stimulation operation for at least a portion of the production wells within the field based on the determined conductive fracture dimensions.

10. The method of claim 1, further comprising:
updating a fracture simulation model based on the determined conductive fracture dimensions: and
optimizing at least one of well spacing parameters, well stacking parameters, treatment parameters, and production parameters for the production wells within the field using the updated fracture simulation model.

11. A method for determining conductive fracture dimensions for production wells within a field, comprising:
identifying production wells within a field that are likely to interact with a monitor well within the field, wherein each production well comprises multiple stages with associated hydraulic fractures extending within a subsurface formation;
performing a production interference test for each production well;
during the production interference test for each production well, measuring production strain data via a fiber optic cable deployed at the monitor well;
determining active measured depths along the monitor well based on a correlation between a temporal strain response for each measured depth and a time at which the production interference test was performed for each production well;
associating each active measured depth with one or more production wells based on which of the production wells reacted to the active measured depth during the corresponding production interference test;
for each active measured depth that has been associated with only one of the production wells, determining an originating stage of a corresponding hydraulic fracture based on a survey for the production well and data corresponding to an expected regional fracture azimuth; and
for each hydraulic fracture for which the originating stage has been determined, determining conductive fracture dimensions for the hydraulic fracture based on the survey for the production well, coordinates of the determined originating stage of the hydraulic fracture, and coordinates of the corresponding active measured depth along the monitor well.

12. The method of claim 11, wherein determining the active measured depths along the monitor well based on the correlation between the temporal strain response for each measured depth and the time at which the production interference test was performed for each production well comprises determining strain change peak locations along the monitor well based on temporal strain changes within the production strain data and correlating each determined strain change peak location with a measured depth of a fracture-driven interaction with the monitor well.

13. The method of claim 12, comprising determining the strain change peak locations along the monitor well based on the temporal strain changes within the production strain data by:
generating a waterfall plot from the production strain data for the production wells, wherein the waterfall plot comprises temporal strain changes within the production strain data along a length of the monitor well;
fitting strain change curves to the temporal strain changes within the waterfall plot for various time instances covering a monitoring period for the production interference tests for the production wells;
selecting one of the strain change curves; and
identifying strain change peak locations within the selected one of the strain change curves.

14. A hydrocarbon well system, comprising:
multiple production wells within a field, wherein each production well comprises:
a wellhead; and
a wellbore extending from the wellhead into a subsurface formation, wherein the wellbore comprises a plurality of stages;
a monitor well within the field, wherein the monitor well is within a vicinity of the production wells, and wherein the monitor well comprises:
a wellhead; and
a wellbore extending from the wellhead into the subsurface formation, wherein the wellbore is equipped with a fiber optic cable; and
a computing system that is communicably coupled to the monitor well, wherein the computing system comprises:
a processor; and
a non-transitory, computer-readable storage medium comprising program instructions that are executable by the processor to cause the processor to:
during hydraulic fracturing of each stage of each production well, measure treatment strain data via the fiber optic cable of the monitor well;
during production interference testing for each production well, measure production strain data via the fiber optic cable of the monitor well;
for each stage of each production well, determine measured depths of fracture-d riven interactions at the monitor well and an interaction corridor for the stage based on the measured treatment strain data;
determine active measured depths along the monitor well based on a correlation between a temporal strain response for each measured depth and a time at which the production interference test was performed for each production well;
associate each active measured depth with one or more production wells based on which of the production wells reacted to the active measured depth during the corresponding production interference test;
for each active measured depth, determine an originating stage of a corresponding hydraulic fracture based on the determined interaction corridors for the stages of the one or more production wells that has been associated with the active measured depth; and
determine conductive fracture dimensions for each hydraulic fracture based on a survey for the production well comprising the originating stage, coordinates of the determined originating stage of the hydraulic fracture, and coordinates of the corresponding active measured depth along the monitor well.

15. The hydrocarbon well system of claim 14, wherein the non-transitory, computer-readable storage medium comprises program instructions that are executable by the processor to cause the processor to, for each stage of each production well, determine the measured depths of the fracture-driven interactions at the monitor well and the interaction corridor for the stage based on the measured treatment strain data by:
generating a waterfall plot from the treatment strain data for the stage, wherein the waterfall plot comprises temporal strain rate changes within the treatment strain data along a length of the monitor well;
identifying measured depths within the waterfall plot at which characteristic fracture opening-and-closing signatures are revealed by the temporal strain rate changes and assigning the identified measured depths as the measured depths of the fracture-driven interactions; and
specifying the interaction corridor for the stage based on the range of the measured depths of the fracture-driven interactions for the stage.

16. The hydrocarbon well system of claim 14, wherein the non-transitory, computer-readable storage medium comprises program instructions that are executable by the processor to cause the processor to determine active measured depths along the monitor well based on a correlation between a temporal strain response for each measured depth and a time at which the production interference test was performed for each production well by determining strain change peak locations along the monitor well based on temporal strain changes within the production strain data, wherein each strain change peak location corresponds to one of the determined measured depths.

17. The hydrocarbon well system of claim 16, wherein the non-transitory, computer-readable storage medium comprises program instructions that are executable by the processor to cause the processor to determine the strain change peak locations along the monitor well based on the temporal strain changes within the production strain data by:
generating a waterfall plot from the production strain data for the production wells, wherein the waterfall plot comprises temporal strain changes within the production strain data along a length of the monitor well;
fitting strain change curves to the temporal strain changes within the waterfall plot for various time instances covering a monitoring period for the production interference tests for the production wells;
selecting one of the strain change curves; and
identifying strain change peak locations within the selected one of the strain change curves.

18. The hydrocarbon well system of claim 14, wherein the non-transitory, computer-readable storage medium comprises program instructions that are executable by the processor to cause the processor to determine the originating stage of the corresponding hydraulic fracture for each active measured depth based on the determined interaction corridors for the stages of the one or more production wells that has been associated with the active measured depth by identifying a conduit production well through which a hydraulic connection is established with the monitor well for instances in which the active measured depth does not correlate to any of the determined interaction corridors for the stages of the one or more production wells that has been associated with the active measured depth.

19. The hydrocarbon well system of claim 14, wherein the determined conductive fracture dimensions for each hydraulic fracture comprises at least one of a fracture height, a fracture length, and a fracture azimuth.
